(19) United States
(12) Patent Application Publication
(10) Pub. No.: US 2015/0082948 A1
(43) Pub. Date: Mar. 26, 2015

(54) Ratcheting Tool

(71) Applicant: Cheng-Wei SU, Taichung City (TW)

(72) Inventor: Jyun-Wun Liao, Taichung City (TW)

(21) Appl. No.: 14/558,810

(22) Filed: Dec. 3, 2014

Related U.S. Application Data
(63) Continuation-in-part of application No. 13/300,852, filed on Nov. 21, 2011, now Pat. No. 8,950,296.

(30) Foreign Application Priority Data
Dec. 6, 2010 (TW) 099142304

(51) Int. Cl. B25B 13/46; B25B 13/06

(52) U.S. Cl. CPC B25B 13/466; B25B 13/06
USPC 81/58.3

(57) ABSTRACT

A ratcheting tool includes first and second driving structures each having a receiving hole. The second driving structure includes an inner flange and multiple teeth. Each tooth has a bottom connected to the inner flange and includes an upper edge, a first side, a second side and beveled ridge. The beveled ridge extends from a juncture between the first side and the upper edge to the inner flange, gradually and inwardly protrudes from an inner surface of the tooth, and includes an engaging bevel and a guiding bevel. The ratcheting tool continuously rotates a fastener without detaching from the fastener.

### CROSS REFERENCE TO RELATED APPLICATION

The present application is a continuation-in part application of U.S. patent application Ser. No. 13/300,852 filed on Nov. 21, 2011.

### BACKGROUND OF THE INVENTION

1. Field of the Invention

The present invention relates to a tool and, more particularly, to a ratcheting tool.

2. Description of the Related Art

U.S. Pat. No. 6,626,067 shows a retention socket. The retention socket includes a drive surface to retain a fastener when it is rotated in one direction. The patent discloses a retention socket including clockwise and counterclockwise drive surfaces and teaches that the amount of surface area of clockwise drive surface which contacts the fastener when being rotated in a clockwise direction is larger than that when being rotated in a counterclockwise direction, but doesn't teach the retention socket operable as a ratcheting socket.

The present invention is, therefore, intended to obviate or at least alleviate the problems encountered in the prior art.

### SUMMARY OF THE INVENTION

According to the present invention, a ratcheting tool includes a first driving structure and at least one second driving structure extending from the first driving structure. The first driving structure includes a first receiving hole. The second driving structure includes a second receiving hole, an inner flange inwardly extending from an inner surface of the second receiving hole, and a plurality of teeth extending from the inner surface of the second receiving hole. Each tooth has a bottom connected to the inner flange and includes an upper edge disposed on a top of the tooth, a first side located at one side of the tooth, a second side located at another side of the tooth and being opposite to the first side, and a beveled ridge extending from a juncture between the one of first and second sides and the upper edge to the inner flange, gradually and inwardly protruding from an inner surface of the tooth. The beveled ridge includes an engaging bevel inclined toward a juncture between the one of the first and second sides and the inner flange and connected to the one of the first and second sides and the inner flange, and a guiding bevel interfacing with the engaging bevel and inclined toward the juncture between the upper edge and another of the first and second sides.

The engaging bevel and the guiding bevel both extend inclinedly from the juncture between the one of the first and second sides and the upper edge. The engaging and guiding bevels extend from the one of the first and second sides and from the upper edge and incline to the inner flange.

The at least one second driving structure is operable in first and second directions. The at least one second driving structure in the first direction driving an object engaged therewith includes the engaging bevel abutting against the object. The at least one second driving structure driven in the second direction reverse to the first direction moving relative to the object includes the guiding bevel provided to allow the object to slide along the second receiving hole.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a ratcheting tool in accordance with the present invention;

FIG. 2 is a cross-sectional view taken along line A-A of FIG. 1;

FIG. 3 is a cross-sectional view showing the ratcheting tool of the present invention in use with a drive extension and a wrenching tool to engage with a bolt;

FIG. 4 is an exploded perspective view of the ratcheting tool, the drive extension, and the wrenching tool shown in FIG. 3;

FIG. 5 is a cross-sectional view taken along line B-B of FIG. 3;

FIG. 6 is a continued cross-sectional view of FIG. 5 and shows the ratcheting tool of the present invention in operation to turn the bolt;

FIG. 7 is a partial, cross-sectional view showing the ratcheting tool of the present invention in operation to turn freely with respect to the bolt;

FIG. 8 is a cross-sectional view taken along line C-C of FIG. 7.

### DETAILED DESCRIPTION OF THE INVENTION

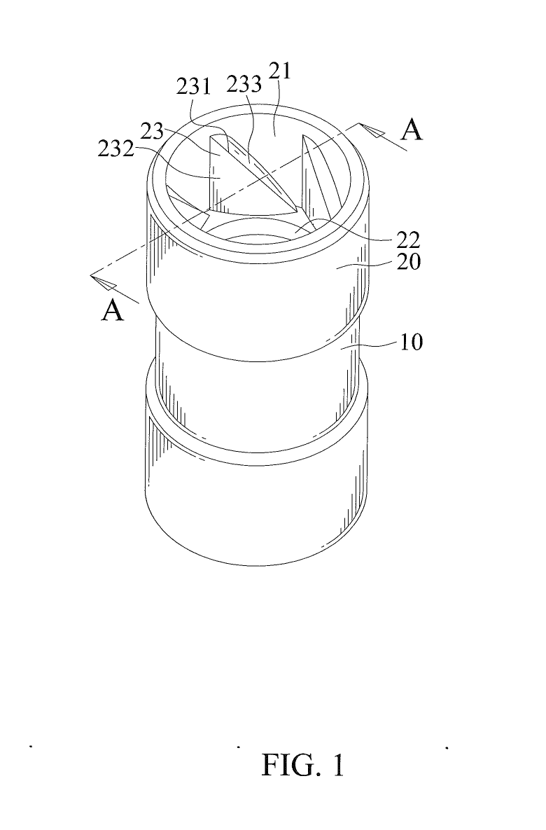

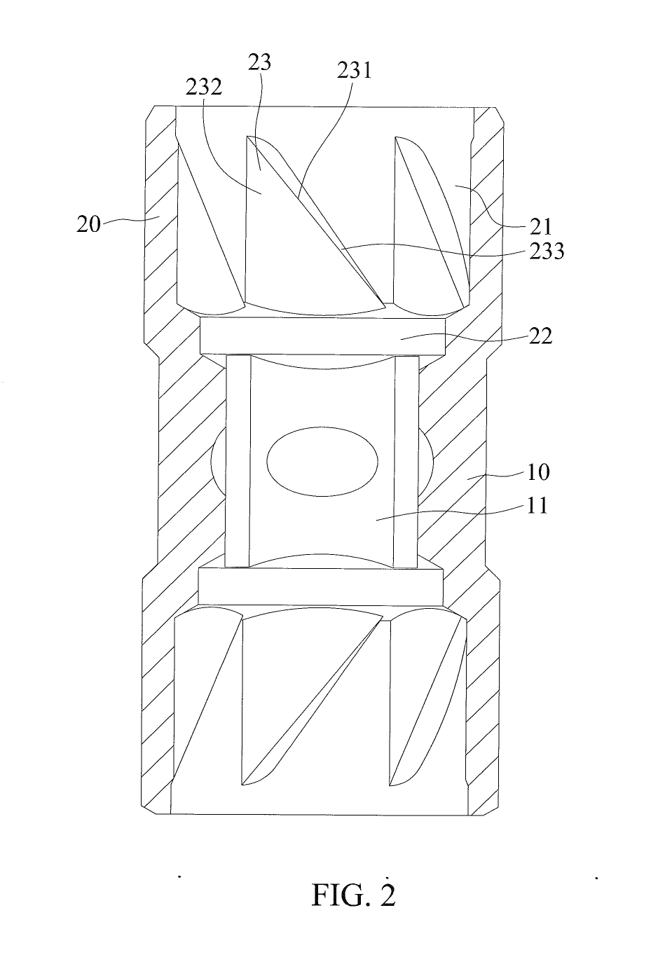

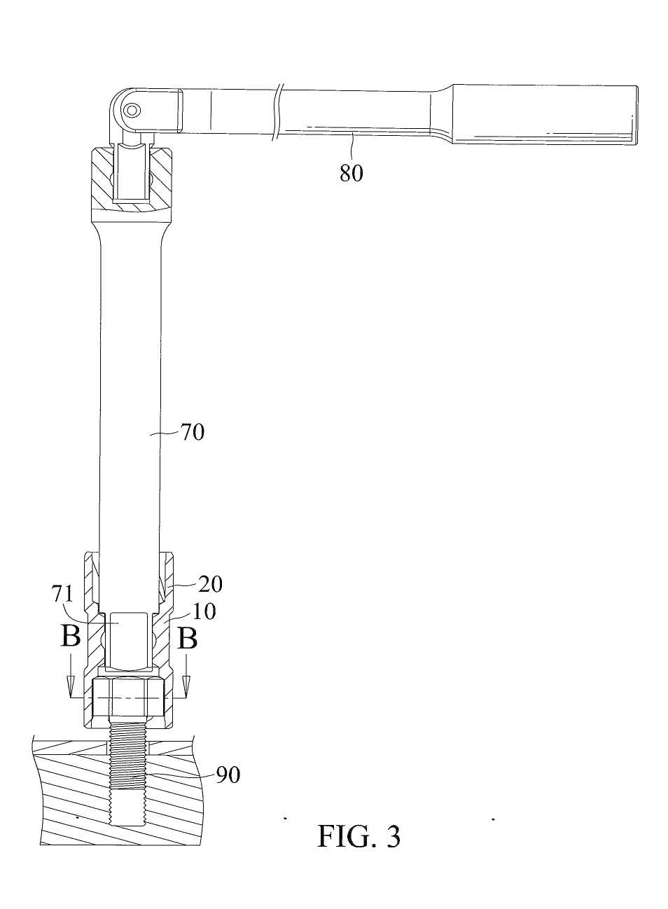

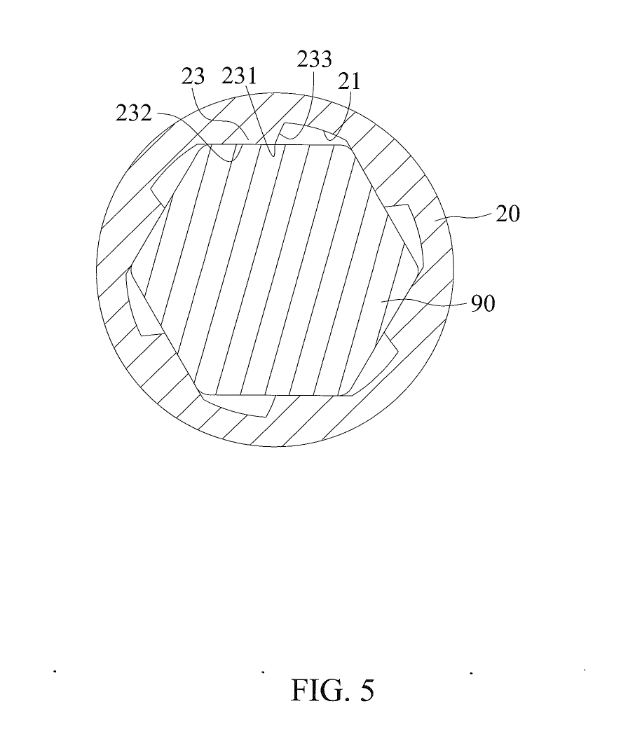

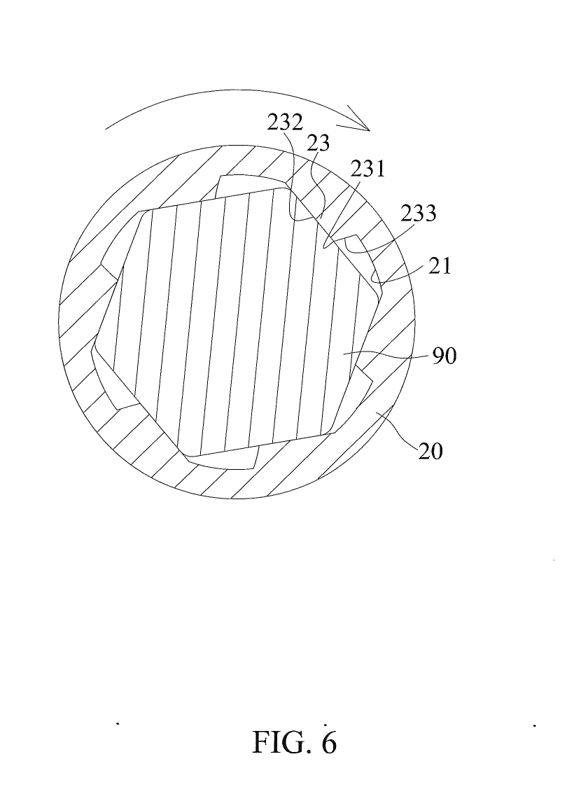

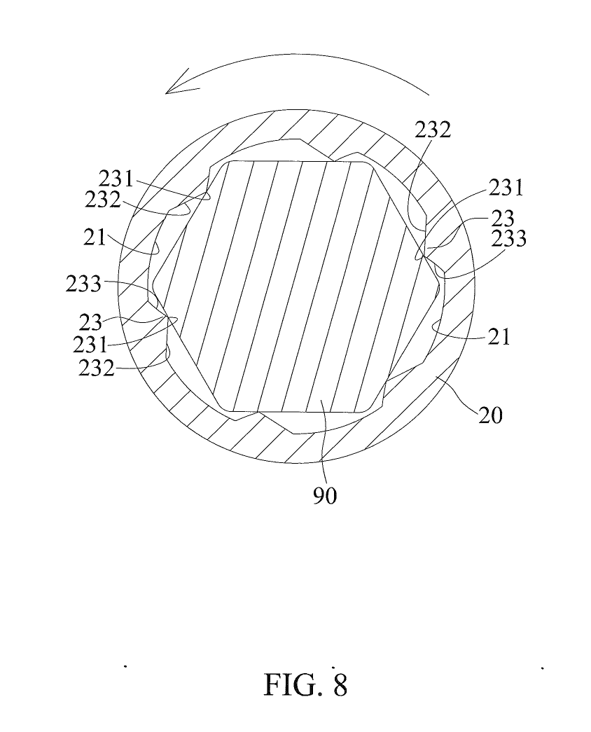

FIGS. 1 through 8 show a ratcheting tool in accordance with the present invention. The ratcheting tool includes a first driving structure 10 and at least one second driving structure 20 extending from the first driving structure 10. The first and at least one second driving structures 10 and 20 are disposed coaxial with respect to one another.

The first driving structure 10 includes a first receiving hole 11. The first driving structure 10 has an inner periphery delimit an inner surface of the first receiving hole 11. The inner surface of the first receiving hole 11 is polygonal. The inner surface of the first receiving hole 11 includes at least one side thereof including a recess for a retaining member.

The at least one second driving structure 20 includes a second receiving hole 21. The second driving structure 20 has an inner periphery delimiting an inner surface of the second receiving hole 21. The first and second receiving holes 11 and 21 are connected to one another. The inner surface of the second receiving hole 21 is annular. The largest cross-sectional size of the inner surface of the first receiving hole 11 is not greater than the largest cross-sectional size of the inner surface of the second receiving hole 21. An inner flange 22 inwardly extends from the inner surface of the second receiving hole 21. A plurality of teeth 23 extends from the inner surface of the second receiving hole 21. The plurality of teeth 23 is arranged circumferentially on the inner surface of the second receiving hole 21. Each of the plurality of teeth 23 has a bottom connected to the inner flange 22. Each of the plurality of teeth 23 includes an upper edge disposed on a top thereof, a first side located at one side thereof, a second side located at another side thereof and being opposite to the first side.

Furthermore, each of the plurality of teeth 23 includes a beveled ridge 231 configured to extend from a juncture between the one of first and second sides and the upper edge to the inner flange 22 and from an inner surface of the inner flange 22, and to gradually and inwardly protrude from an inner surface of each of the plurality of teeth 23. The beveled ridge 231 includes an engaging bevel 232 inclined toward a juncture between the one of the first and second sides and the inner flange 22 and connected to the one of the first and second sides and the inner flange 22. Moreover, the beveled ridge 231 includes a guiding bevel 233 interfacing with the engaging bevel 232 and inclined toward the juncture between the upper edge and another of the first and second sides. The engaging bevel 232 and the guiding bevel 233 both extend inclinedly from the juncture between the one of the first and second sides and the upper edge. The engaging and guiding bevels 232 and 233 extend from the one of the first and second sides and from the upper edge and incline to the inner flange 22.

Furthermore, each of the plurality of teeth 23 has a connecting surface located among the beveled ridge, the second side and the upper edge. The connecting surface is connected with the second side, the upper edge and the guiding bevel of the beveled ridge.

The ratcheting tool includes the at least one second driving structure 20 in first and second directions. The at least one second driving structure 20 in the first direction driving an object 90 engaged therewith including the engaging bevel 232 abutting against the object 90. The at least one second driving structure 20 driven in the second direction reverse to the first direction moving relative to the object 90 including the guiding bevel 233 provided to allow the object to slide along the second receiving hole 21. In the embodiment, the object 90 is a bolt which has a hexagonal head.

Here, there are two second driving structures 20 extend from the first driving structure 10. The first driving structure 10 interconnects and is disposed between the two second driving structures 20. The two second driving structures 20 are symmetrically disposed with respect to the first driving structure 10.

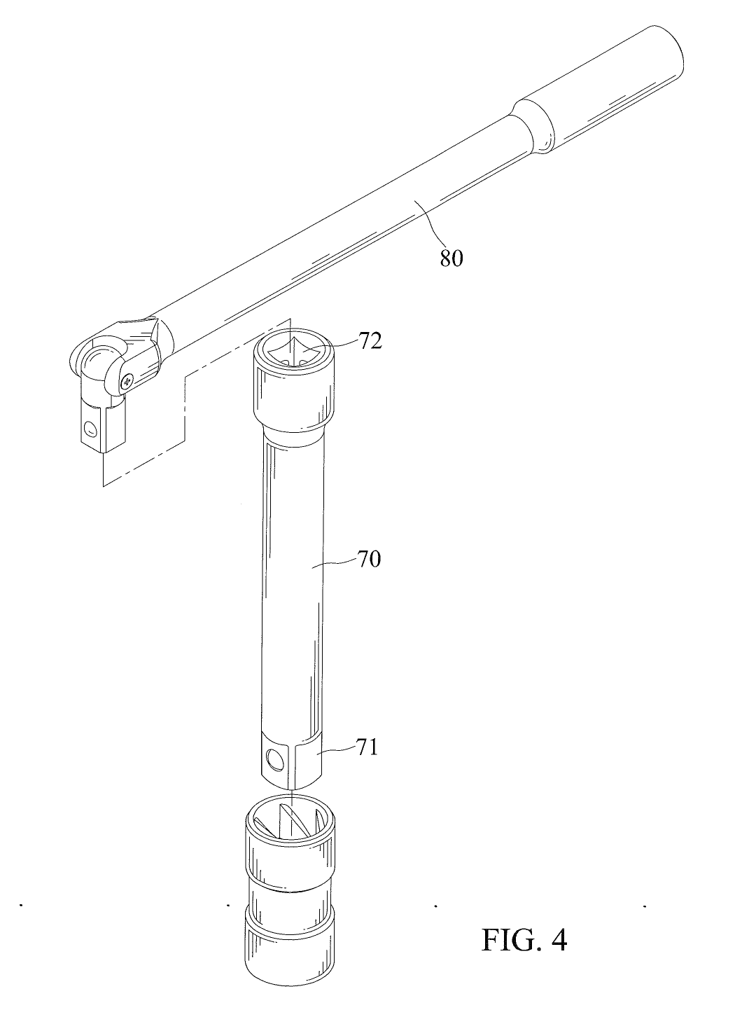

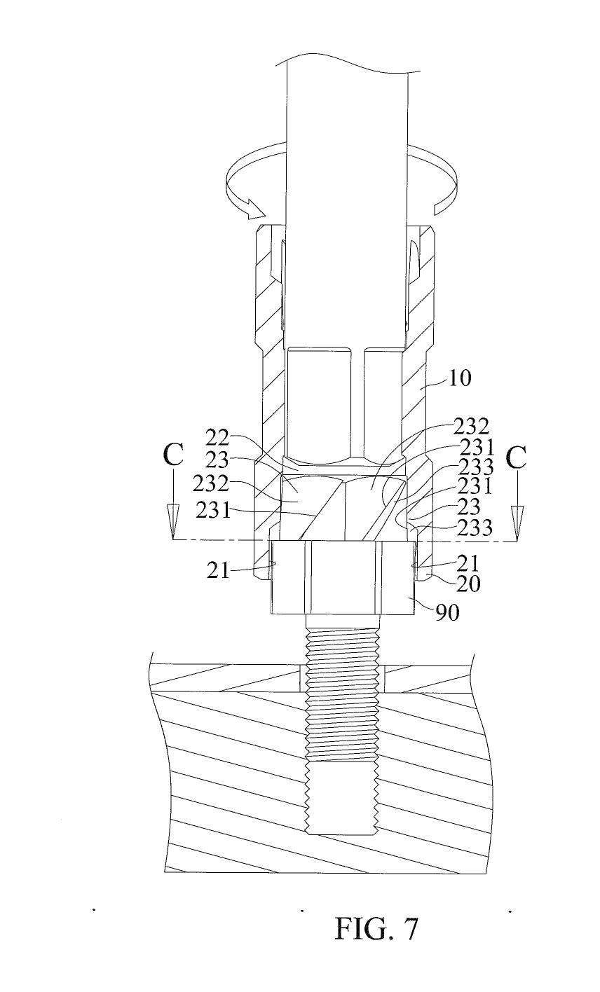

In addition, FIGS. 4 and 7 show the ratcheting tool cooperate with a drive extension 70 and a wrenching tool 80. The drive extension 70 and the wrenching tool 80 give a user leverage to turn the object 90 efficiently. The drive extension 70 has a first end configured to include a polygonal engaging protrusion 71 and a second end configured to include a polygonal engaging hole 72. The first and second ends of the drive extension 70 are located oppositely along a longitudinal length thereof. The polygonal engaging protrusion 71 and the first receiving hole 11 have corresponding shapes. The engaging protrusion 71 of the drive extension 70 is adapted to insert through the second receiving hole 21 of one of the two second driving structures 20 because the largest cross-sectional size of the inner surface of the first receiving hole 11 is not greater than the largest cross-sectional size of the inner surface of the second receiving hole 21, and then engages in the first receiving hole 11. The drive extension 70 is operable to turn the ratcheting tool because the engaging protrusion 71 and the first receiving hole 11 have corresponding polygonal shapes. In addition, the wrenching tool 80 has a first end including a driving head and a second end opposite the first end. The first and second ends of the tool are located oppositely along a longitudinal length thereof. The driving head is configured to include a polygonal stem. The stem and the engaging hole 72 have the corresponding shapes. The driving head is adapted to engage in the engaging hole 72. The wrenching tool 80 is operable to turn the drive extension 70 because the stem and the engaging hole 72 have corresponding polygonal shapes. The second end of the wrenching tool 80 is adapted to be gripped during operation thereof. The second end of the wrenching tool 80 is therefore configured to include an ergonomic handle. The user holds the second end of the wrenching tool 80 to gain leverage.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ratcheting tool, comprising:
a first driving structure including a first receiving hole;
at least one second driving structure extending from the first driving structure and including:
a second receiving hole;
an inner flange inwardly extending from an inner surface of the second receiving hole;
a plurality of teeth extending from the inner surface of the second receiving hole, with each of the plurality of teeth having a bottom connected to the inner flange and including:
an upper edge disposed on a top of each of the plurality of teeth;
a first side located at one side of the each of the plurality of teeth;
a second side located at another side of the each of the plurality of teeth and being opposite to the first side; and
a beveled ridge extending from a juncture between the one of first and second sides and the upper edge to the inner flange, gradually and inwardly protruding from an inner surface of the tooth, and including:
an engaging bevel inclined toward a juncture between the one of the first and second sides and the inner flange and connected to the one of the first and second sides and the inner flange; and
a guiding bevel interfacing with the engaging bevel and inclined toward the juncture between the upper edge and another of the first and second sides; wherein the engaging bevel and the guiding bevel both extend inclinedly from the juncture between the one of the first and second sides and the upper edge; wherein the engaging and guiding bevels extend from the one of the first and second sides and from the upper edge and incline to the inner flange; and wherein the at least one second driving structure is operable in first and second directions, with the at least one second driving structure in the first direction driving an object engaged therewith including the engaging bevel abutting against the object, with the at least one second driving structure driven in the second direction reverse to the first direction moving relative to the object including the guiding bevel provided to allow the object to slide along the second receiving hole.

2. The ratcheting tool as claimed in claim 1, wherein each of the plurality of teeth has a connecting surface located among the beveled ridge, the second side and the upper edge, and wherein the connecting surface is connected with the second side, the upper edge and the guiding bevel of the beveled ridge.

3. The ratcheting tool as claimed in claim 2, wherein the beveled ridge of each of the plurality of teeth extends from an inner surface of the inner flange.

4. The ratcheting tool as claimed in claim 1, wherein the beveled ridge of each of the plurality of teeth extends from an inner surface of the inner flange.

5. The ratcheting tool as claimed in claim 3, wherein the inner surface of the second receiving hole is annular, and wherein the plurality of teeth is arranged circumferentially on the inner surface of the second receiving hole.

6. The ratcheting tool as claimed in claim 5, wherein an inner surface of the first receiving hole is polygonal, wherein the inner surface of the first receiving hole includes at least one side thereof including a recess for a retaining member, and wherein a largest cross-sectional size of the inner surface of the first receiving hole is not greater than a largest cross-sectional size of the inner surface of the second receiving hole.

7. The ratcheting tool as claimed in claim 6, wherein the first and second receiving holes are connected to one another.

8. The ratcheting tool as claimed in claim 1, wherein the at least one second driving structure includes two second driving structures, and wherein the first driving structure interconnects and is disposed between the two second driving structures.

9. The ratcheting tool as claimed in claim 8, wherein the inner surface of the second receiving hole is annular, and wherein the plurality of teeth is arranged circumferentially on the inner surface of the second receiving hole.

10. The ratcheting tool as claimed in claim 9, wherein an inner surface of the first receiving hole is polygonal, wherein the inner surface of the first receiving hole includes at least one side thereof including a recess for a retaining member, and wherein a largest cross-sectional size of the inner surface of the first receiving hole is not greater than a largest cross-sectional size of the inner surface of the second receiving hole.

11. The ratcheting tool as claimed in claim 10, wherein the first and second receiving holes 11 and 21 are connected to one another.

12. The ratcheting tool as claimed in claim 6, wherein the two driving structures are disposed on opposite ends of the first driving structure axially.
